(19) United States
(12) Patent Application Publication
(10) Pub. No.: US 2026/0086534 A1
(43) Pub. Date: Mar. 26, 2026

(54) RULE-BASED EDGE DEVICE PROCESSING

(71) Applicant: Rockwell Automation Technologies, Inc., Mayfield Heights, OH (US)

(72) Inventors: Jonathan A. Mills, Mayfield Heights, OH (US); Nathaniel S. Sandler, Chagrin Falls, OH (US); Taryl J. Jasper, South Euclid, OH (US); Clark L. Case, Aurora, OH (US); Michael A. Spaner, Deep River, CT (US)

(21) Appl. No.: 18/897,703

(22) Filed: Sep. 26, 2024

(51) Int. Cl. G05B 19/4155

(52) U.S. Cl. CPC G05B 19/4155; G05B 2219/31368

(57) ABSTRACT

Systems and methods described herein may enable operations including receiving, from an industrial automation device associated with an industrial automation system, process-related data. The operations may include generating a subset of processed data based on processing the process-related data according to a rule. Based on the processing, the operations may include generating context data that includes an indication of the rule. By doing so, less than a whole set of industrial process-related data may be transmitted for further processing, such as to a cloud-computing system for further processing.

### BACKGROUND

The present disclosure generally relates to tools for managing data handling of operational technology (OT) networks.

Industrial automation systems may be used to provide automated control of one or more actuators in an industrial setting. OT networks may be used to communicatively couple industrial automation systems and/or industrial automation components within an industrial automation system. As connectivity of OT network increases, such as with advent of smarter and enhanced industrial automation devices with expanded monitoring capabilities, data generated in association with operation of the OT network has also increased in volume. Such large datasets may be difficult to transmit for processing. Accordingly, techniques for implementing new processing operations that reduce these datasets while maintaining the analytical value of the datasets is desired.

This section is intended to introduce the reader to aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a system may include an edge device communicatively coupled to an industrial control system via a local control system. The edge device may include a local control system that performs operations. The operations may include receiving, via the industrial control system, process-related data obtained in association with an industrial automation device disposed within an operational technology network and a device identifier of the industrial automation device. The operations may include reading, via a memory, one or more rules based on the device identifier and a type of the process-related data. The one or more rules include a first rule having a first priority and a second rule having a second priority. The operations may include determining to apply the first rule based on the first priority exceeding the second priority. The operations may include generating a subset of processed data based on processing the process-related data according to the first rule and one or more additional rules of the one or more rules. The operations may include generating context data that includes an indication of the first rule and the one or more additional rules. The operations may include sending the subset of processed data and the context data to a cloud server outside the operational technology network. The operations may include controlling operation of the industrial automation device based on the subset of processed data.

In another embodiment, an edge device may include an input structure that couples to an industrial control system. The industrial control system may communicatively couple to an industrial automation device disposed within an operational technology network. The edge may include a processor and a memory accessible by the processor. The memory may store a first rule indicating a first operation and a second operation to be performed and instructions that, when executed by the processor, cause the processor to perform operations. The operations may include receiving, from the industrial control system, process-related data associated with the industrial automation device and a device identifier of the industrial automation device. The operations may include reading, from the memory, the first rule based on the device identifier and a type of the process-related data. The operations may include generating a subset of processed data based on processing the process-related data according to the first operation and the second operation based on the first rule. The operations may include generating context data based on an indication of the first rule. The operations may include sending, to a cloud server outside the operational technology network, the subset of processed data and the context data.

In a further embodiment, a method may include receiving, from an industrial automation device associated with an industrial automation system and disposed within an operational technology network, process-related data and a device identifier of the industrial automation device. The method may include reading from memory a rule based on the device identifier and a type of the process-related data. The method may include generating a subset of processed data based on processing the process-related data according to the rule. The method may include generating context data comprising an indication of the rule. The method may include transmitting the subset of processed data and the context data to an information technology device associated with the industrial automation system and disposed within an informational technology network.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present embodiments will become better understood when the following detailed description is read with reference to the accompanying drawings in which like characters represent like parts throughout the drawings, wherein:

FIG. 1 is a schematic view of an industrial automation system, in accordance with embodiments presented herein;

FIG. 2 is a block diagram of example components that could be used in the industrial automation system of FIG. 1, in accordance with embodiments presented herein;

FIG. 3 is a perspective view of an example of the industrial automation system of FIG. 1 controlled by an industrial control system, in accordance with an embodiment;

FIG. 4 is a block diagram of an example operational technology (OT) network, including the industrial control system of FIG. 3, that coordinates with a container orchestration system, in accordance with an embodiment;

FIG. 5 is a block diagram of an edge device with local control circuitry to analyze and identify vital data and context data based on a dataset, ruleset(s), and/or processing operations, in accordance with an embodiment;

FIG. 6 is a flow chart of a process of operating the edge device of FIG. 5 to generate the vital data and the context data of FIG. 5 based on feature extraction operations enabled via one or more rules, in accordance with an embodiment;

FIG. 7 is a flow chart of a process of operating the edge device of FIG. 5 to identify and apply the one or more rules of FIG. 6 when generating the vital data and the context data of FIG. 6, in accordance with an embodiment; and

FIG. 8 is a diagrammatic representation of an example of operations performed by the edge device of FIG. 5 when generating the vital data and context data based on operations of FIGS. 5-7, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to operational technology (OT) devices providing data to an edge device to generate vital data based on feature extraction operations. In some cases, the edge device may be coupled to an informational technology (IT) network and may similarly process IT data based on feature extraction to generate vital data subsets for transmission to cloud-computing systems outside of the IT network and/or OT network.

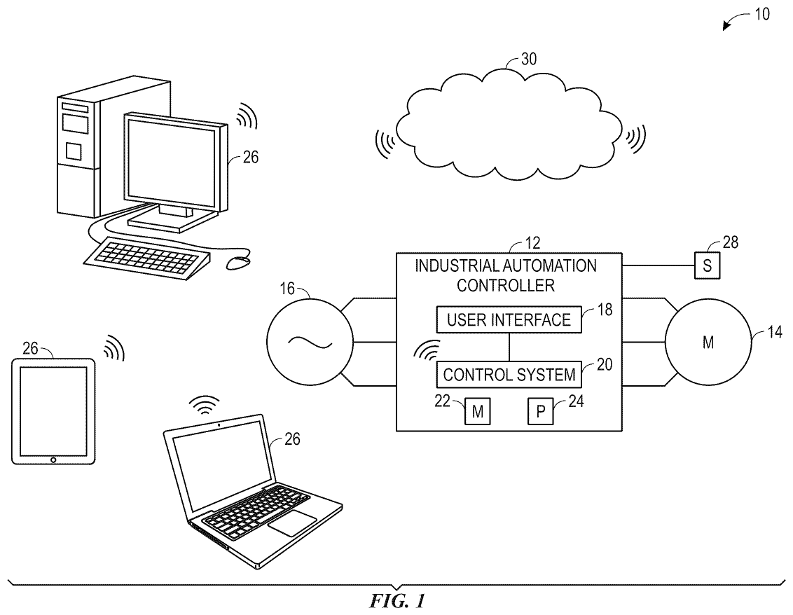

To elaborate, some industrial automation performance monitoring software or processing methods may use large quantities of data from an OT device (e.g., industrial automation device), which may be unrealistic to transmit to a computing device associated with a cloud-based computing infrastructure due to bandwidth and time constraints. Indeed, sending data up into the cloud for processing and then bringing the data back down to the edge device and/or the industrial automation device, can be very expensive. Accordingly, doing most of the features extraction and/or data processing on the edge device and then sending results up to the cloud reduces the amount of data being transmitted up to the cloud. An edge device included between the industrial automation system and the cloud to may be used to process the large quantities of data from the OT device based on rules to generate a smaller subset of data to be transmitted to the cloud. By doing so, system performance may improve by enabling robust data analytic operations to occur without corresponding burdens of bandwidth of data transfer slowing communication speeds or efficiencies. When connected to communicate with IT devices as well, the edge device may similarly handle data from IT devices. Additional details with regard to generating vital data subsets based on feature extraction systems and methods and transmitted said subsets to one or more cloud-computing systems are described further herein and with reference to FIGS. 1-8.

By way of introduction, FIG. 1 is a schematic view of an example industrial automation system 10 in which the embodiments described herein may be implemented. As shown, the industrial automation system 10 includes a controller 12 and an actuator 14 (e.g., a motor). The industrial automation system 10 may also include, or be coupled to, a power source 16. The power source 16 may include a generator, an external power grid, a battery, or some other source of power. The controller 12 may be a stand-alone control unit that controls multiple industrial automation components (e.g., a plurality of motors 14), a controller 12 that controls the operation of a single automation component (e.g., motor 14), or a subcomponent within a larger industrial automation system 10. In the instant embodiment, the controller 12 includes a display/operator interface 18, such as a human machine interface (HMI), and a control system 20, which may include a memory 22 and a processor 24. The controller 12 may include a cabinet or some other enclosure for housing various components of the industrial automation system 10, such as a motor starter, a disconnect switch, or the like.

The control system 20 may be programmed (e.g., via computer readable code or instructions stored on the memory 22, such as a non-transitory computer readable medium, and executable by the processor 24) to provide signals for controlling the motor 14. In certain embodiments, the control system 20 may be programmed according to a specific configuration desired for a particular application. For example, the control system 20 may be programmed to respond to external inputs, such as reference signals, alarms, command/status signals, etc. The external inputs may originate from one or more relays or other electronic devices. The programming of the control system 20 may be accomplished through software or firmware code that may be loaded onto the internal memory 22 of the control system 20 (e.g., via a locally or remotely located computing device 26) or programmed via the display/operator interface 18 of the controller 12. The control system 20 may respond to a set of operating parameters. The settings of the various operating parameters may determine the operating characteristics of the controller 12. For example, various operating parameters may determine the speed or torque of the motor 14 or may determine how the controller 12 responds to the various external inputs. As such, the operating parameters may be used to map control variables within the controller 12 or to control other devices communicatively coupled to the controller 12. These variables may include, for example, speed presets, feedback types and values, computational gains and variables, algorithm adjustments, status and feedback variables, programmable logic controller (PLC) control programming, and the like.

In some embodiments, the controller 12 may be communicatively coupled to one or more sensors 28 for detecting operating temperatures, voltages, currents, pressures, flow rates, and other measurable variables associated with the industrial automation system 10. With feedback data from the sensors 28, the control system 20 may keep detailed track of the various conditions under which the industrial automation system 10 may be operating. For example, the feedback data may include conditions such as actual motor speed, voltage, frequency, power quality, alarm conditions, etc. In some embodiments, the feedback data may be communicated back to the computing device 26 for additional analysis.

The computing device 26 may be communicatively coupled to the controller 12 via a wired or wireless connection. The computing device 26 may receive inputs from a user defining an industrial automation project using a native application running on the computing device 26 or using a website accessible via a browser application, a software application, or the like. The user may define the industrial automation project by writing code, interacting with a visual programming interface, inputting or selecting values via a graphical user interface, or providing some other inputs. The user may use licensed software and/or subscription services to create, analyze, and otherwise develop the project. The computing device 26 may send a project to the controller 12 for execution. Execution of the industrial automation project causes the controller 12 to control components (e.g., motor 14) within the industrial automation system 10 through performance of one or more tasks and/or processes. In some applications, the controller 12 may be communicatively positioned in a private network and/or behind a firewall, such that the controller 12 does not have communication access outside a local network and is not in communication with any devices outside the firewall, other than the computing device 26. The controller 12 may collect feedback data during execution of the project, and the feedback data may be provided back to the computing device 26 for analysis. Feedback data may include, for example, one or more execution times, one or more alerts, one or more error messages, one or more alarm conditions, one or more temperatures, one or more pressures, one or more flow rates, one or more motor speeds, one or more voltages, one or more frequencies, and so forth. The project may be updated via the computing device 26 based on the analysis of the feedback data.

The computing device 26 may be communicatively coupled to a cloud server 30 or remote server via the internet, or some other network, such as any suitable wired or wireless network. In one embodiment, the cloud server 30 may be operated by the manufacturer of the controller 12, a software provider, a seller of the controller 12, operator of the controller 12, owner of the controller 12, etc. The cloud server 30 may be operated by a service provider and provide services enabled by one or more service provider systems. The cloud server 30 may be used to help customers create and/or modify projects, to help troubleshoot any problems that may arise with the controller 12, develop policies, or to provide other services (e.g., project analysis, enabling, restricting capabilities of the controller 12, data analysis, controller firmware updates, etc.). The cloud server 30 may be one or more servers operated by the manufacturer, software provider, seller, service provider, operator, or owner of the controller 12. The cloud server 30 may be disposed at a facility owned and/or operated by the manufacturer, software provider, seller, service provider, operator, or owner of the controller 12. In other embodiments, the cloud server 30 may be disposed in a datacenter in which the manufacturer, software provider, seller, service provider, operator, or owner of the controller 12 owns or rents server space. In further embodiments, the cloud server 30 may include multiple servers operating in one or more data center to provide a cloud computing environment.

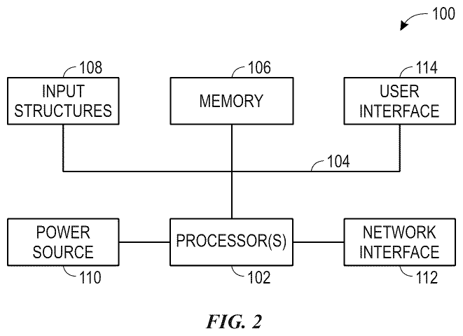

FIG. 2 illustrates a block diagram of example components of a computing device 100 that could be used as the computing device 26, the cloud server 30, the controller 12, or some other device within the industrial automation system 10 shown in FIG. 1. As used herein, a computing device 100 may be implemented as one or more computing systems including laptop, notebook, desktop, tablet, HMI, or workstation computers, as well as server type devices or portable, communication type devices, such as cellular telephones and/or other suitable computing devices.

As illustrated, the computing device 100 may include various hardware components, such as one or more processors 102, one or more busses 104, memory 106, input structures 108, a power source 110, a network interface 112, a user interface 114, and/or other computer components useful in performing the functions described herein.

The one or more processors 102 may include, in certain implementations, microprocessors configured to execute instructions stored in the memory 106 or other accessible locations. Alternatively, the one or more processors 102 may be implemented as application-specific integrated circuits (ASICs), field-programmable gate arrays (FPGAs), and/or other devices designed to perform functions discussed herein in a dedicated manner. As will be appreciated, multiple processors 102 or processing components may be used to perform functions discussed herein in a distributed or parallel manner.

The memory 106 may encompass any tangible, non-transitory medium for storing data or executable routines. Although shown for convenience as a single block in FIG. 2, the memory 106 may encompass various discrete media in the same or different physical locations. The one or more processors 102 may access data in the memory 106 via one or more busses 104.

The input structures 108 may allow a user to input data and/or commands to the device 100 and may include mice, touchpads, touchscreens, keyboards, controllers, and so forth. The power source 110 can be any suitable source for providing power to the various components of the computing device 100, including line and battery power. In the depicted example, the device 100 includes a network interface 112. Such a network interface 112 may allow communication with other devices on a network using one or more communication protocols. In the depicted example, the device 100 includes a user interface 114, such as a display that may display images or data provided by the one or more processors 102. The user interface 114 may include, for example, a monitor, a display, and so forth. As will be appreciated, in a real-world context a processor-based system, such as the computing device 100 of FIG. 2, may be employed to implement some or all of the present approach, such as performing the functions of the controller, the computing device 26, and/or the remote server 30 shown in FIG. 1, as well as other memory-containing devices.

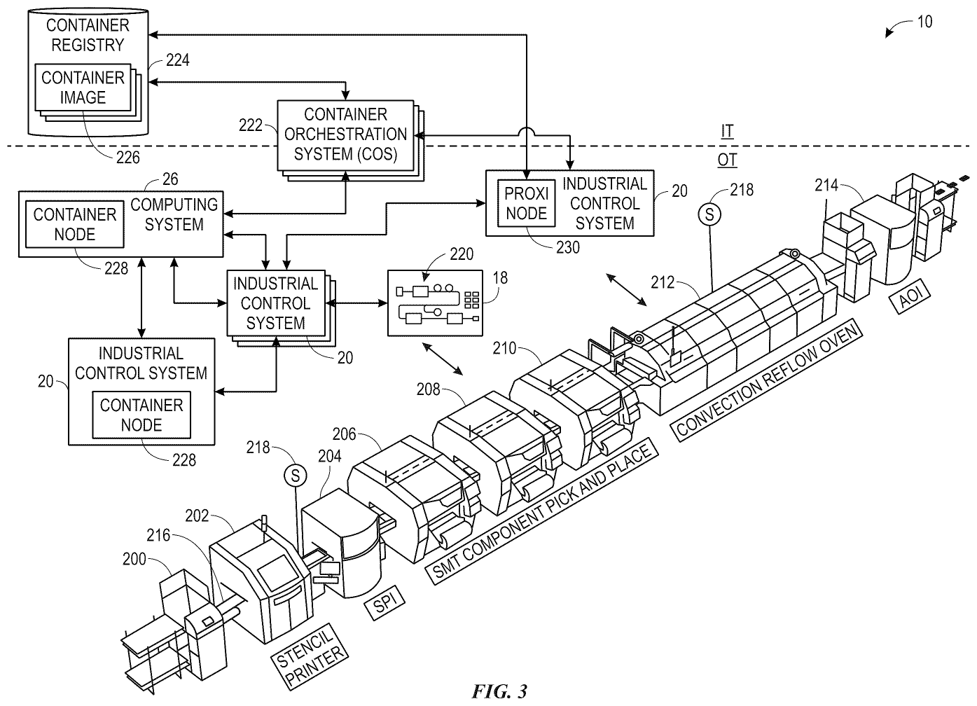

FIG. 3 is a perspective view of an example of the industrial automation system 10 of FIG. 1. The industrial automation system 10 includes stations 200, 202, 204, 206, 208, 210, 212, 214 having machine components and/or machines to conduct functions within an automated process, such as silicon wafer manufacturing, as is depicted. The automated process may begin at a station 200 used for loading objects, such as substrates, into the industrial automation system 10 via a conveyor section 216. For example, objects may be transported along the conveyor section 216 to station 202 to perform a first action, such a printing solder paste to the substrate via stenciling. As objects exit from the station 202, the objects may be transported via the conveyor section 216 to a station 204 for solder paste inspection (SPI) to inspect printer results, to a station 206, 208, and 210 for surface mount technology (SMT) component placement, to a station 212 for convection reflow oven to melt the solder to make electrical couplings, and finally to a station 214 for automated optical inspection (AOI) to inspect the object manufactured (e.g., the manufactured printed circuit board). After the objects proceed through the various stations, the objects may be removed from the station 14H, for example, for storage in a warehouse or for shipment. It should be understood, however, that for other applications, the particular system, machine components, machines, stations, and/or conveyors may be different or specially adapted to the application.

For example, the industrial automation system 10 may include machinery to perform various operations in a compressor station, an oil refinery, a batch operation for making food items, chemical processing operations, brewery operations, mining operations, a mechanized assembly line, and so forth. Accordingly, the industrial automation system 10 may include a variety of operational components, such as electric motors, valves, actuators, temperature elements, pressure sensors, or a myriad of machinery or devices used for manufacturing, processing, material handling, and other applications. The industrial automation system 10 may also include electrical equipment, hydraulic equipment, compressed air equipment, steam equipment, mechanical tools, protective equipment, refrigeration equipment, power lines, hydraulic lines, steam lines, and the like. Some example types of equipment may include mixers, machine conveyors, tanks, skids, specialized original equipment manufacturer machines, and the like. In addition to the equipment described above, the industrial automation system 10 may also include motors, protection devices, switchgear, compressors, and the like. Each of these described operational components may correspond to and/or generate a variety of operational technology (OT) data regarding operation, status, sensor data, operational modes, alarm conditions, or the like, that may be desirable to output for analysis with IT data from an IT network, for storage in an IT network, for analysis with expected operation set points (e.g., thresholds), or the like.

In certain embodiments, one or more properties of the industrial automation system 10 equipment, such as the stations 200, 202, 204, 206, 208, 210, 212, 214, may be monitored and controlled by the industrial control systems 20 for regulating control variables. For example, sensing devices (e.g., sensors 218) may monitor various properties of the industrial automation system 10 and may be used by the industrial control systems 20 at least in part in adjusting operations of the industrial automation system 10 (e.g., as part of a control loop). In some cases, the industrial automation system 10 may be associated with devices used by other equipment. For instance, scanners, gauges, valves, flow meters, and the like may be disposed on or within the industrial automation system 10. Here, the industrial control systems 20 may receive data from the associated devices and use the data to perform their respective operations more efficiently. For example, a controller of the industrial automation system 10 associated with a motor drive may receive data regarding a temperature of a connected motor and may adjust operations of the motor drive based on the data.

The industrial control systems 20 may include or be communicatively coupled to the display/operator interface 18 (e.g., a human-machine interface (HMI)) and to devices of the industrial automation system 10. It should be understood that any suitable number of industrial control systems 20 may be used in a particular industrial automation system 10 embodiment. The industrial control systems 20 may facilitate representing components of the industrial automation system 10 through programming objects that may be instantiated and executed to provide simulated functionality similar or identical to the actual components, as well as visualization of the components, or both, on the display/operator interface 18. The programming objects may include code and/or instructions stored in the industrial control systems 20 and executed by processing circuitry of the industrial control systems 20. The processing circuitry may communicate with memory circuitry to permit the storage of the component visualizations.

As illustrated, a display/operator interface 18 may be configured to depict representations 220 of the components of the industrial automation system 10. The industrial control system 20 may use data transmitted by the sensors 218 to update visualizations of the components via changing one or more statuses, states, and/or indications of current operations of the components. These sensors 218 may be any suitable device adapted to provide information regarding process conditions. Indeed, the sensors 218 may be used in a process loop (e.g., control loop) that may be monitored and controlled by the industrial control system 20. As such, a process loop may be activated based on process inputs (e.g., an input from the sensor 218) or direct input from a person via the display/operator interface 18. The person operating and/or monitoring the industrial automation system 10 may reference the display/operator interface 18 to determine various statuses, states, and/or current operations of the industrial automation system 10 and/or for a particular component. Furthermore, the person operating and/or monitoring the industrial automation system 10 may adjust to various components to start, stop, power-down, power-on, or otherwise adjust an operation of one or more components of the industrial automation system 10 through interactions with control panels or various input devices.

The industrial automation system 10 may be considered a data-rich environment with several processes and operations that each respectively generate a variety of data. For example, the industrial automation system 10 may be associated with material data (e.g., data corresponding to substrate or raw material properties or characteristics), parametric data (e.g., data corresponding to machine and/or station performance, such as during operation of the industrial automation system 10), test results data (e.g., data corresponding to various quality control tests performed on a final or intermediate product of the industrial automation system 10), or the like, that may be organized and sorted as OT data. In addition, sensors 218 may gather OT data indicative of one or more operations of the industrial automation system 10 or the industrial control system 20. In this way, the OT data may be analog data or digital data indicative of measurements, statuses, alarms, or the like associated with operation of the industrial automation system 10 or the industrial control system 20.

The industrial control systems 20 described above may operate in an OT space in which OT data is used to monitor and control OT assets, such as the equipment illustrated in the stations 200, 202, 204, 206, 208, 210, 212, 214 of the industrial automation system 10 or other industrial equipment. The OT space, environment, or network generally includes direct monitoring and control operations that are coordinated by the industrial control system 20 and a corresponding OT asset. For example, a programmable logic controller (PLC) may operate in the OT network to control operations of an OT asset (e.g., drive, motor, and/or high-level controllers). The industrial control systems 20 may be specifically programmed or configured to communicate directly with the respective OT assets.

A container orchestration system 222, on the other hand, may operate in an information technology (IT) environment. That is, the container orchestration system 222 may include a cluster of multiple computing devices that coordinates an automatic process of managing or scheduling work of individual containers for applications within the computing devices of the cluster. In other words, the container orchestration system 222 may be used to automate various tasks at scale across multiple computing devices. By way of example, the container orchestration system 222 may automate tasks such as configuring and scheduling deployment of containers, provisioning and deploying containers, determining availability of containers, configuring applications in terms of the containers that they run in, scaling of containers to equally balance application workloads across an infrastructure, allocating resources between containers, performing load balancing, traffic routing, and service discovery of containers, performing health monitoring of containers, securing the interactions between containers, and the like. In any case, the container orchestration system 222 may use configuration files to determine a network protocol to facilitate communication between containers, a storage location to save logs, and the like. The container orchestration system 222 may also schedule deployment of containers into clusters and identify a host (e.g., node) that may be best suited for executing the container. After the host is identified, the container orchestration system 222 may manage the lifecycle of the container based on predetermined specifications.

With the foregoing in mind, it should be noted that containers refer to technology for packaging an application along with its runtime dependencies. That is, containers include applications that are decoupled from an underlying host infrastructure (e.g., operating system). By including the run time dependencies with the container, the container may perform in the same manner regardless of the host in which it is operating. In some embodiments, containers may be stored in a container registry 224 as container images 226. The container registry 224 may be any suitable data storage or database that may be accessible to the container orchestration system 222. The container image 226 may correspond to an executable software package that includes the tools and data employed to execute a respective application. That is, the container image 226 may include related code for operating the application, application libraries, system libraries, runtime tools, default values for various settings, and the like.

By way of example, an integrated development environment (IDE) tool may be employed by a user to create a deployment configuration file that specifies a desired state for the collection of nodes of the container orchestration system 222. The deployment configuration file may be stored in the container registry 224 along with the respective container images 226 associated with the deployment configuration file. The deployment configuration file may include a list of different pods and a number of replicas for each pod that should be operating within the container orchestration system 222 at any given time. Each pod may correspond to a logical unit of an application, which may be associated with one or more containers. The container orchestration system 222 may coordinate the distribution and execution of the pods listed in the deployment configuration file, such that the desired state is continuously met. In some embodiments, the container orchestration system 222 may include a master node that retrieves the deployment configuration files from the container registry 224, schedules the deployment of pods to the connected nodes, and ensures that the desired state specified in the deployment configuration file is met. For instance, if a pod stops operating on one node, the master node may receive a notification from the respective worker node that is no longer executing the pod and deploy the pod to another worker node to ensure that the desired state is present across the cluster of nodes.

As mentioned above, the container orchestration system 222 may include a cluster of computing devices, computing systems, or container nodes that may work together to achieve certain specifications or states, as designated in the respective container. In some embodiments, container nodes 228 may be integrated within industrial control systems 20 as shown in FIG. 3. That is, container nodes 228 may be implemented by the industrial control systems 20, such that they appear as worker nodes to the master node in the container orchestration system 222. In this way, the master node of the container orchestration system 222 may send commands to the container nodes 228 that are also configured to perform applications and operations for the respective industrial equipment.

With this in mind, the container nodes 228 may be integrated with the industrial control systems 20, such that they serve as passive-indirect participants, passive-direct participants, or active participants of the container orchestration system 222. As passive-indirect participants, the container nodes 228 may respond to a subset of all of the commands that may be issued by the container orchestration system 222. In this way, the container nodes 228 may support limited container lifecycle features, such as receiving pods, executing the pods, updating a respective filesystem to included software packages for execution by the industrial control system 20, and reporting the status of the pods to the master node of the container orchestration system 222. The limited features implementable by the container nodes 228 that operate in the passive-indirect mode may be limited to commands that the respective industrial control system 20 may implement using native commands that map directly to the commands received by the master node of the container orchestration system 222. Moreover, the container node 228 operating in the passive-indirect mode of operation may not be capable to push the packages or directly control the operation of the industrial control system 20 to execute the package. Instead, the industrial control system 20 may periodically check the file system of the container node 228 and retrieve the new package at that time for execution.

As passive-direct participants, the container nodes 228 may operate as a node that is part of the cluster of nodes for the container orchestration system 222. As such, the container node 228 may support the full container lifecycle features. That is, container node 228 operating in the passive-direct mode may unpack a container image and push the resultant package to the industrial control system 20, such that the industrial control system 20 executes the package in response to receiving it from the container node 228. As such, the container orchestration system 222 may have access to a worker node that may directly implement commands received from the master node onto the industrial control system 20.

In the active participant mode, the container node 228 may include a computing module or system that hosts an operating system (e.g., Linux) that may continuously operate a container host daemon that may participate in the management of container operations. As such, the active participant container node 228 may perform any operations that the master node of the container orchestration system 222 may perform. By including a container node 228 operating in the OT space, the container orchestration system 222 is capable of extending its management operations into the OT space. That is, the container node 228 may provision devices in the OT space, serve as a proxy node 230 to provide bi-directional coordination between the IT space and the OT space, and the like. For instance, the container node 228 operating as the proxy node 230 may intercept orchestration commands and cause industrial control system 20 to implement appropriate machine control routines based on the commands. The industrial control system 20 may confirm the machine state to the proxy node 230, which may then reply to the master node of the container orchestration system 222 on behalf of the industrial control system 20.

Additionally, the industrial control system 20 may share an OT device tree via the proxy node 230. As such, the proxy node 230 may provide the master node with state data, address data, descriptive metadata, versioning data, certificate data, key information, and other relevant parameters concerning the industrial control system 20. Moreover, the proxy node 230 may issue requests targeted to other industrial control systems 20 to control other OT devices. For instance, the proxy node 230 may translate and forward commands to a target OT device using one or more OT communication protocols, may translate and receive replies from the OT devices, and the like. As such, the proxy node 230 may perform health checks, provide configuration updates, send firmware patches, execute key refreshes, and other OT operations for other OT devices.

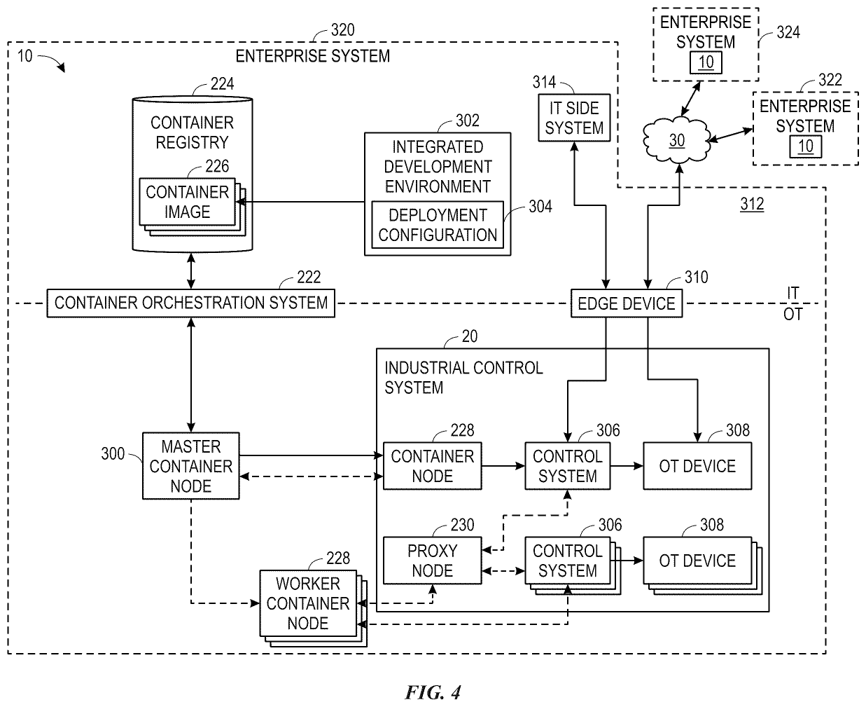

FIG. 4 illustrates a block diagram that depicts the relative positions of the container node 228 and the proxy node 230 with respect to the container orchestration system 222, relative to an example implementation in enterprise system 320. As mentioned above, the container orchestration system 222 may include a collection of nodes that are used to achieve a desired state of one or more containers across multiple nodes. As shown in FIG. 4, the container orchestration system 222 may include a master container node 300 that may execute control plane processes for the container orchestration system 222. The control plane processes may include the processes that enable the container orchestration system 222 to coordinate operations of the container nodes 228 to meet the desired states. As such, the master container node 300 may execute an applications programming interface (API) for the container orchestration system 222, a scheduler component, core resource controllers, and the like. By way of example, the master container node 300 may coordinate all of the interactions between nodes of the cluster that make up the container orchestration system 222. Indeed, the master container node 300 may be responsible for deciding the operations that will run on container nodes 228 including scheduling workloads (e.g., containerized applications), managing the workloads' lifecycle, scaling, and upgrades, managing network and storage resources for the workloads, and the like. The master container node 300 may run an API server to handle requests and status updates received from the container nodes 228.

By way of operation, an integrated development environment (IDE) tool 302 may be used by an operator to develop a deployment configuration file 304. As mentioned above, the deployment configuration file 304 may include details regarding the containers, the pods, constraints for operating the containers/pods, and other information that describe a desired state of the containers specified in the deployment configuration file 304. In some embodiments, the deployment configuration file 304 may be generated in a YAML file, a JSON file, or other suitable file format that is compatible with the container orchestration system 222. After the IDE tool 302 generates the deployment configuration file 304, the IDE tool 302 may transmit the deployment configuration file 304 to the container registry 224, which may store the file along with container images 226 representative of the containers stored in the deployment configuration file 304.

In some embodiments, the master container node 300 may receive the deployment configuration file 304 via the container registry 224, directly from the IDE tool 302, or the like. The master container node 300 may use the deployment configuration file 304 to determine a location to gather the container images 226, determine communication protocols to use to establish networking between container nodes 228, determine locations for mounting storage volumes, locations to store logs for the containers, and the like.

Based on the desired state provided in the deployment configuration file 304, the master container node 300 may deploy containers to the container host nodes 228. That is, the master container node 300 may schedule the deployment of a container based on constraints (e.g., CPU or memory availability) provided in the deployment configuration file 304. After the containers are operating on the container nodes 228, the master container node 300 may manage the lifecycle of the containers to ensure that the containers specified by the deployment configuration file 304 are operating according to the specified constraints and the desired state.

Keeping the foregoing in mind, the industrial control system 20 may not use an operating system (OS) that is compatible with the container orchestration system 222. That is, the container orchestration system 222 may be configured to operate in the IT space that involves the flow of digital information. In contrast, the industrial control system 20 may operate in the OT space that involves managing the operation of physical processes and the machinery used to perform those processes. For example, the OT space may involve communications that are formatted according to OT communication protocols, such as FactoryTalk LiveData, EtherNet/IP. Common Industrial Protocol (CIP), OPC Direct Access (e.g., machine to machine communication protocol for industrial automation developed by the OPC Foundation), OPC Unified Architecture (OPCUA), or any suitable OT communication protocol (e.g. DNP3, Modbus, Profibus, LonWorks, DALI, BACnet, KNX, EnOcean). Because the industrial control systems 20 operate in the OT space, the industrial control systems may not be capable of implementing commands received via the container orchestration system 222.

In certain embodiments, the container node 228 may be programmed or implemented in the industrial control system 20 to serve as a node agent that can register the industrial control system 20 with the master container node 300. The node agent may or may not be the same as the proxy node 230 shown in FIG. 3. For example, the industrial control system 20 may include a PLC that cannot support an operating system (e.g., Linux) for receiving and/or implementing requested operations issued by the container orchestration system 222. However, the PLC may perform certain operations that may be mapped to certain container events. As such, the container node 228 may include software and/or hardware components that may map certain events or commands received from the master container node 300 into actions that may be performed by the PLC. After converting the received command into a command interpretable by the PLC, the container node 228 may forward the mapped command to the PLC that may implement the mapped command. As such, the container node 228 may operate as part of the cluster of nodes that make up the container orchestration system 222, while a first control system 306 (e.g., PLC) that coordinates the OT operations for a second OT device 308 in the industrial control system 20. The first control system 306 may include a controller, such as a PLC, an HLC, a programmable automation controller (PAC), or any other controller that may monitor, control, and operate an industrial automation device or component.

The OT device 308 may correspond to an industrial automation device or component. The OT device 308 may include any suitable industrial device that operates in the OT space. As such, the OT device 308 may be involved in adjusting physical processes being implemented via the industrial automation system 10. In some embodiments, the OT device 308 may include motor control centers, motors, HMIs, operator interfaces, contactors, starters, sensors, drives, relays, protection devices, switchgear, compressors, network switches (e.g., Ethernet switches, modular-managed, fixed-managed, service-router, industrial, unmanaged) edge devices, mixers, machine conveyors, tanks, skids, specialized original equipment manufacturer machines, scanners, gauges, valves, flow meters, and the like. The OT device 308 may also be associated with devices used by the equipment such as scanners, gauges, valves, flow meters, and the like. Each of the OT devices 308 and IT devices (e.g., IT device 342) of the IT side systems 314 may respectively include one or more memory 106, one or more processors 102, one or more network interfaces 112, one or more power sources 110, one or more user interfaces 114, one or more input structures 108, one or more sensors, one or more actuators, and the like.

In the present embodiments described herein, the control system 306 may thus perform actions based on commands received from the container node 228. By mapping certain container lifecycle states into appropriate corresponding actions implementable by the control system 306, the container node 228 enables program content for the industrial control system 20 to be containerized, published to certain registries, and deployed using the master container node 300, thereby bridging the gap between the IT-based container orchestration system 222 and the OT-based industrial control system 20.

In some embodiments, the container node 228 may operate in an active mode, such that the container node may invoke container orchestration commands for other container nodes 228. For example, a proxy node 230 may operate as a proxy or gateway node that is part of the container orchestration system 222. The proxy node 230 may be implemented in a sidecar computing module that has an operating system (OS) that supports the container host daemon. In another embodiment, the proxy node 230 may be implemented directly on a core of the control system 306 that is configured (e.g., partitioned), such that the control system 306 may operate using an operating system that allows the container node 228 to execute orchestration commands and serve as part of the container orchestration system 222. In either case, the proxy node 230 may serve as a bi-directional bridge for IT/OT orchestration that enables automation functions to be performed in IT devices based on OT data and in OT devices 308 based on IT data. For instance, the proxy node 230 may acquire OT device tree data, state data for an OT device, descriptive metadata associated with corresponding OT data, versioning data for OT devices 308, certificate/key data for the OT device, and other relevant OT data via OT communication protocols. The proxy node 230 may then translate the OT data into IT data that may be formatted to enable the master container node 300 to extract relevant data (e.g., machine state data) to perform analysis operations and to ensure that the container orchestration system 222 and the connected control systems 306 are operating at the desired state. Based on the results of its scheduling operations, the master container node 300 may issue supervisory control commands to targeted OT devices via the proxy nodes 230, which may translate and forward the translated commands to the respective control system 306 via the appropriate OT communication protocol.

In addition, the proxy node 230 may also perform certain supervisory operations based on its analysis of the machine state data of the respective control system 306. As a result of its analysis, the proxy node 230 may issue commands and/or pods to other nodes that are part of the container orchestration system 222. For example, the proxy node 230 may send instructions or pods to other worker container nodes 228 that may be part of the container orchestration system 222. The worker container nodes 228 may corresponds to other container nodes 228 that are communicatively coupled to other control systems 306 for controlling other OT devices 308. In this way, the proxy node 230 may translate or forward commands directly to other control systems 306 via certain OT communication protocols or indirectly via the other worker container nodes 228 associated with the other control systems 306. In addition, the proxy node 230 may receive replies from the control systems 306 via the OT communication protocol and translate the replies, such that the nodes in the container orchestration system 222 may interpret the replies. In this way, the container orchestration system 222 may effectively perform health checks, send configuration updates, provide firmware patches, execute key refreshes, and provide other services to OT devices 308 in a coordinated fashion. That is, the proxy node 230 may enable the container orchestration system to coordinate the activities of multiple control systems 306 to achieve a collection of desired machine states for the connected OT devices 308.

As shown in FIG. 4, the industrial automation system 10 may include one or more edge devices 310 that control data flow within the industrial automation system 10 (e.g., the OT network) as well as between the industrial automation system 10 and the IT network 312 (e.g., the IT network). The edge device may be disposed on a network edge between the industrial automation system 10 (e.g., an enterprise system) and/or the IT network 213 and a communication network associated with the cloud server 30. In some cases, the edge device 310 may be coupled to the cloud server 30. The cloud server 30 may connect to one or more enterprise systems 320, 322, 324, which each may be associated with one or more respective industrial automation systems 10. For purposes of this disclosure, descriptions are made relative to enterprise system 320. However, it should be understood that systems and methods described herein may apply to enterprise systems 322, 324.

Elaborating on the edge device 310, the edge device 310 may be a router, a switch, or the like. In certain embodiments, the edge device 310 may receive a policy or a policy update (e.g., a security update) from the IT network 312 that may include, for example, an enterprise system, a server device, a plant management system, or the like. A policy is a set of one or more rules or procedures that govern access and use of an organization's OT assets (e.g., industrial automation devices associated with OT machines). For example, a policy may define provisions addressing acceptable usage of OT/IT assets, antivirus management, data backup and disaster recovery, change management, cryptography usage, data and asset classification, data retention, data support and operations, data usage, email/messaging protection policies, user identity and access management, incident response, threat protection, internet usage restrictions, mobile device policy, OT/IT network security, password and credential protocols, firmware/patch management, personnel security, physical and environmental security, malware/spyware/ransomware detection, system update schedules, wireless network access, guest access, and so forth. Accordingly, a policy may govern, for example, how to manage who has access to what OT devices, what files and/or communications should be encrypted, what ports can be used for what purposes, characteristics of passwords (e.g., number of characters, upper and lower case letters, numbers, special characters), how often users must change their passwords, how often backups are done, how long backups are retained, guidelines for accessing wireless internet, what happens when a threat occurs, processes for onboarding/offboarding users as they start and leave positions, the process that occurs when a user changes roles, maintenance procedures, and so forth. The enterprise system may include software and/or hardware components that support business processes, information flows, reporting, data analytics, and the like for an enterprise, where these operations may be performed based on policies.

In addition to policies, the cloud server 30 may provide operation recommendations to the industrial automation system 10. The cloud server 30 may sometimes communicate other information relative to operations of the OT devices 308 to the edge device 310. These recommendations may include set point recommendations, operational adjustment recommendations, degradation notices, alarms, firmware updates to an OT device 308, firmware updates other connected systems of the industrial automation system 10, or the like.

These operations, as well as development of the policies, described above, may be enabled or improved by the cloud server 30 receiving data associated with the OT device 308 operation and/or the industrial automation system 10 operation. By doing so, the cloud server 30 may change or recommend operational and policy changes based on a real-time system understanding of operations of the industrial automation system 10, as well as the subsystems and underlying OT devices enabling the operations. Further, once a set of policies or a set of recommended operations have been implemented, data collected during the operation of the industrial automation system 10 (e.g., run-time data, help ticket data, incident data, vulnerability data, data received from one or more service providers, one or more customers, one or more partner organizations, one or more suppliers, and so forth) may be used to generate recommended updates to the current set of implemented and/or enforced policies or operations.

Thus, as industrial automation systems 10 become more connected and complex, the cloud server 30 may receive more frequent feedback data resulting from more dynamic processes and data generation systems. Thus, it may be desired to reduce an amount of data feedback and/or to provide the subset of data with context data to reduce an overall computational complexity of providing such a cloud-connected system and to improve quality of data provided to the cloud server 30. By processing industrial automation system 10 data (e.g., OT device data, IT device data) to provide vital subsets of that data and associated context data to the cloud server 30, less bandwidth may be used for these data transmission operations, which may enable further scaling and/or further data processing operations to occur at faster computational speeds.

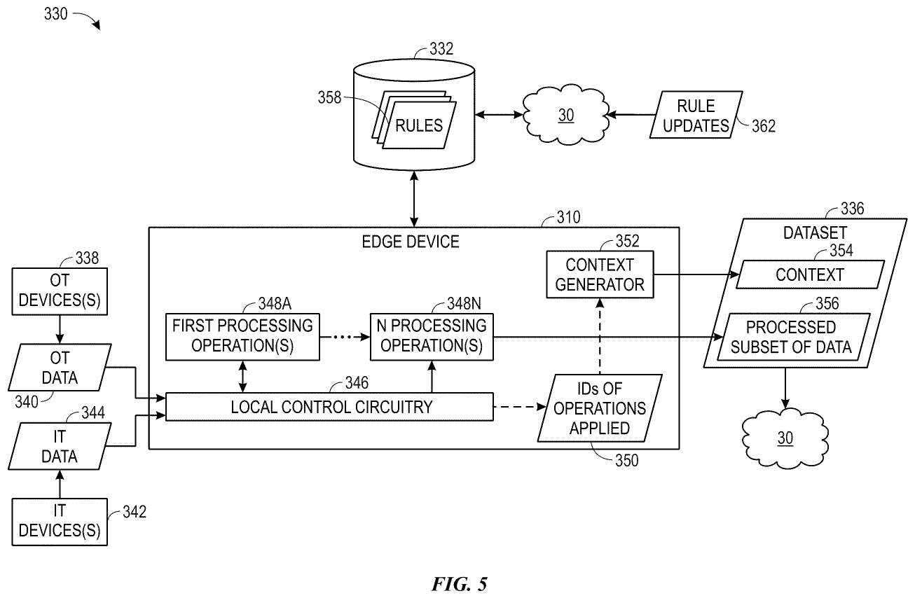

FIG. 5 is a block diagram 330 of an edge device 310 that processes data (e.g., OT data 340, IT data 344) to provide processed subsets of that data 356 (e.g., vitals data) and associated context data 354 to the cloud server 30 as a dataset 336. The edge device 310 may do so via local control system 346 operating to provide a rule enforcement engine to analyze and identify vital data and context data based on a dataset, ruleset(s), and/or processing operations. OT devices 338 may refer to one or more OT devices 308 from FIG. 4, which may include industrial automation devices, sensors, assets, or the like. Similarly, IT devices 342 may refer generally to one or more devices disposed with the IT network 312 capable of providing or being associated with data sent to the edge device 310.

To elaborate, the edge device 310 may receive OT data 340 from OT devices 338 and/or IT data 344 from IT devices 342. OT data 340 may include any suitable data able to be aggregated and transmitted via the industrial control system 20, for example, IGBT temperature, heat sink temperature, power consumed at a given time, current, voltage, torque, process state indications, or the like. IT data 344 may include any suitable data able to be aggregated and transmitted via the edge device 310 to the cloud server 30, for example, an IT device 342 configuration, an OT device 338 configuration, industrial automation system 10 production data, enterprise system 320 work order completion data, operator or user data, scheduling data, network security data, or the like. Any suitable data may be received that was obtained relative to an operation of one or more OT devices 338 and/or IT devices 342 and/or accessible via the industrial control system 20. The data may be acquired by sensors and/or may be data reported by an industrial control system 20 related to asset or industrial automation operations. Sometimes data is received (e.g., via data streams) from OT devices 338 and/or IT devices 342, organized in a data model, pre-processed, and sent as a dataset to an edge device. In some cases, the edge device 310 may collect the data from a data stream over time into a dataset associated with values and timestamps. Time periods of analysis may be manually set or set using machine learning models or other suitable methods. Other methods of accessing data for edge processing include the edge device 310 reading the data from the asset (e.g., drive) and/or the asset or industrial control system publishing the data such that the edge device 310 can read the published data. The edge device 310 may subscribe to the asset or the industrial control system 20 to receive data updates. In some cases, the industrial control system 20 may perform processing operations on the process data and then transmit processed data to the edge device for rule-based feature extraction. Some processing tasks distributed between the OT device 338 and the edge device 310 may depend upon the capabilities of the local control system 346, compute available on the edge device 310, speed of data, bandwidth to transmit data, as well as other considerations.

Indeed, the edge device 310 may receive run-time data 340 from one or more OT devices 338, input the received data to the rule enforcement engine running on the edge device 310 via local control system 346 (e.g., in a container, outside a container), and generate a processed subset of data 356 from the received data 340, 344. The rules 358 applied may be specific to the enterprise (e.g., enterprise system 320) of the industrial automation system 10. This data processing may be generally referred to as “feature extraction” and may be enabled via a rule enforcement engine run on the edge device 310 based on the local control system 346 executing instructions stored in memory. The processed subset of data 356 may have reduced in size according to the rules 358 relative to the received data 340, 344. The processed subset of data 356 may be further processed by the cloud server 30 and/or IT network 312 systems to be prepared to be presented to a user for approval, presented to a user for consideration, or otherwise processed by an additional computing device.

The rule enforcement engine may be executed via local control system 346 operating to implement one or more rules 358, where each rule 358 defines one or more data processing operations 348 (e.g., 348A-348N) to perform to one or more subsets of the data 340, 344, in response to one or more triggers being met. A rule 358 may define one or more processing operations 348 to be performed. A first rule 358 may chain with a second rule 358, such as to be triggered in response to the first rule 358 being fulfilled. Rules 358 may be additive, separate, or sequential. A rule 358 may correspond to industry standards (e.g., to be applied at multiple enterprises 320, 322, 324, industry-specific standards), site-specific standards (e.g., to be applied at a specific industrial automation systems 10), user-defined standards (e.g., to be applied to one or more OT devices 338 or IT devices 342, service-provider standards, manufacturer standards, enterprise-wide standards (e.g., to be applied at multiple industrial automation systems 10 operated by a same enterprise 340, enterprise-specific standards). One rule 358 may trigger another rule 358. For example, a rule 358 generated based on input from an operator, via a human machine interface or via an IT device 342, may further define a threshold, operational range, processing operation, or the like of a rule 358 corresponding to the industry standards. Indeed, the cloud server 30 rule 358 may represent a “floor” set of rules configured for safe operation of the OT devices 338. Customer rulesets (e.g., subset of rules 358 adjusted using customer rules) may be specific to the customer or the customer's industry and may represent operational parameter windows to achieving desired throughput, quality control standards, tolerances, noise levels, production schedules, cleanliness, product and/or raw material handling guidelines, and so forth. Relative to a “floor” set of rules 358 representing potentially a baseline level of operational compliance, the customer ruleset may present more strict, higher, lower, or the like alternative compliance that is different from the “floor” operation.

In some cases, a rule subset may include a portion of the rules 358. The edge device 310 may store rules 358 in the storage 332. The edge device 310 may store the rules 358 from different rulesets based on assigning priorities to the respective rules 358 according to which ruleset included the rule. A respective rule set may be generated by different rule sources, such as the cloud server 30, an IT side system 312, or the like. A first rule subset may be generated by the cloud server 30 and a second rule subset may be generated by a respective IT device 342. Priorities may be associated with respective rules 358 of the respective rule subsets. The local control system 346 may apply rules 358 based on the priorities. In some cases, a cloud server 30 rule 358 may take priority. In some cases, the IT device 342 (e.g., enterprise) rule 358 takes priority. Certain triggers may change which rule 358 takes priority. For example, an enterprise rule 358 may define that the cloud server 30 rule 358 is followed in response to a first threshold being exceeded, and that another enterprise rule 358 is followed in response to a second threshold being exceeded. The local control system 346 may determine to apply the cloud server 30 generated rule 358 when the rule 358 corresponds to a more stringent triggering operation than the enterprise system 320 generated rule 358. However, the local control system 346 may determine to apply the enterprise system 320 generated rule 358 when the rule 358 corresponds to a more stringent or equally as stringent triggering operation than the cloud server 30 generated rule 358 generated rule 358. This may improve industrial automation system 10 operation by automating regulation compliance by reducing a likelihood of intentional or unintentional circumvention of governance affecting one or more enterprise systems 320, 322, 324 and enabling third-party service providers to consume computing resources managing the rules 358 as opposed to enterprise system 320.

Rules 358 may define which processing operations 348 to apply to the received data 340, 344 based on characteristics of the received data 340, 344, such as type of the data, devices associated with the data, product IDs associated with the data, process, unit, or subsystem within the data originated from, a sensing frequency used to acquire the data, whether the data is analog or digital data, whether the data represents an alarm, and so on. Rules may define conditional rules to process the data according to and thus the local control system 346 may track identifiers (IDs) of operations applied 350 on the received data 340, 344 to keep track of which operations were performed relative to conditions being met. The IDs of operations applied 350 may be stored in memory or cache memory.

After the subset of data is generated from the received data 340, 344, the local control system 346 may instruct a context generator 352 to use the IDs of operations applied 350 to generate context data 354 to associate with a processed subset of data 356 to generate the dataset 336. The context generator 352 may associate additional information with the subset of data 356 to provide further context. The context generator 352 may associate a sentence of explanation of the data to provide context explaining the vital data generated. For example, the context data 354 may include an indication of a manufacturer name, a product name, a model name, a model number, a serial number, a firmware version, a software version, a port status, captured network traffic, Common Industrial Protocol (CIP) discovery data, link layer discovery protocol (LLDP) data, network traffic data, Open Platform Communications Unified Architecture (OPC-UA) data, a type of sensor used to generate the base data 340, 344, and so forth. The cloud server 30 may use language model-based processing (e.g., natural language model processing, large language model processing) to further analyze and store the processed subset of data 356 (e.g., vital data) and the context data 354, which may include policy generation, operation setpoint generation, work order generation, and the like. In some cases, the cloud server 30 may instruct the edge device 310 and/or IT side system 314 to instruct the industrial control system 20 to adjust the industrial automation system 10 operation.

In providing the rule enforcement engine, the local control system 346 may analyze collected data (e.g., OT data 340, IT data 344) according to rules 358 received from the cloud server 30. In some embodiments, the collected data may be discovery data and/or network topology data that may be analyzed to determine characteristics of the OT network and, in some embodiments, generate visualizations (e.g., network maps) of the OT network. The collected data may include characteristic information (e.g., IP addresses, MAC addresses, serial numbers) may be used to identify and/or characterize components that appear in data until a topology (e.g., map) of the OT network can be generated. In such embodiments, the data may include a manufacturer name, a product name, a model name, a model number, a serial number, a firmware version, a software version, a port status, captured network traffic, Common Industrial Protocol (CIP) discovery data, link layer discovery protocol (LLDP) data, network traffic data, Open Platform Communications Unified Architecture (OPC-UA) data, and so forth. OT data 340 may also be collected from the industrial automation systems 10 in a facility during operation and may include software/firmware update data, warning data, error code data, operational data, temperature data, pressure data, speed/rotation data, quality control data, or the like. The IT data 344 may include, for example, design artifacts, help ticket data, incident data, vulnerability data, network traffic data, captured network traffic (e.g., data packets), device logs, data received from cloud server 30, output data received from the cloud server 30 based on user inputs on an IT device of IT side system 314 to process data from an OT device 308 notes provided by an operator, software/firmware update data, warning data, error code data, operational data, temperature data, pressure data, speed/rotation data, quality control data, some of which may be reported to IT devices 342 from the OT devices 338, and so forth. Design artifacts and/or operational data may be aggregated and used to generate recommended rules or modifications to existing rules 358. The recommended rules may be implemented and/or enforced within the enterprise and/or distributed to the facilities or particular industrial automation systems 10 within the enterprise. Once rules 358, or updates to rules, have been implemented and/or enforced, dataset 336 may be generated and sent the cloud server 30 for further processing, analysis, presentation, and/or to revise operations of the OT devices 338 and/or the IT devices 342 as part of a feedback control loop.

For example, following feature extraction, vital data (e.g., extracted features, alarms, warnings, informational notices, etc.) may be transmitted to the cloud server 30 via an application programming interface (API) and/or to one or more devices of the IT network 312 (e.g., via an API). Vital data may correspond to a subset of the process data 356 and any characteristics deemed indicated by the data 340, 344 through the edge device 310 processing the data. The edge device 310 may transmit the vital data (e.g., subset of the process data 356) with context data 354, which may be metadata that indicates the rules applied to generate the vital data. The cloud server 30 and/or one or more devices of IT network 312 may generate a work order that provides an operator with some of the vital data along with maintenance operation instructions determined related based on the vital data, the context data 354, aggregating data for monitoring, or the like. The rules 358 may also enable the edge device 310 to perform alarm generation based on analysis of the data 340, 344 in real-time or over time with trend analysis. The work order, alert, or graphical user interface (GUI) generated to communicate or based on the vital data may be customized based on a type of user that would be viewing the work order, alert, or GUI. Once provided to the cloud server 30, data may be accessed, viewed, and in some cases manipulated, using the GUI accessed via a web browser, mobile device application, or the like. In some cases, the cloud server 30 may perform further data processing to identify, for example, possible causes of the issue and/or possible solutions.

In some embodiments, the enterprise system 320 may purchase or subscribe to services, such as machine learning models, training data for training machine learning models, and/or recommended rules or setpoints to the enterprise system 320, provided by one or more cloud servers 30. In some embodiments, the enterprise system 320 may collect data 340, 344 to transmit to the service provider via the cloud server 30 that provides some information concerning operations performed by OT devices 338. Accordingly, the cloud server 30 may use data 340, 344 collected from one or more customer edge devices 310 to improve machine learning models and/or the training data provided to the enterprises. Customers (e.g., enterprise systems 320, 322, 324) may choose to opt in or opt out of providing data, like data 340, 344 to the cloud server 30. In some cases, because enterprise systems 320, 322, 324 may be hesitant to share data, data may be anonymized, masked, pseudonymized, generalized, or otherwise scrubbed before being transmitted to the service provider. These data processing operations may be implemented via rule enforcement engine implemented by the local control circuitry 346. For example, some or all characteristic data elements (e.g., names, addresses, IP addressed, MAC addresses, phone numbers, network names, passwords, employee names, employee numbers, employee information, etc.) within the data 340, 344 may be identified and removed and/or changed before being transmitted as the processed subset of data 356. Further, data elements related to industrial processes, settings of the industrial automation systems, set points, trade secrets, intellectual property, or other proprietary information may be identified and removed or changed before being transmitted as the processed subset of data 356. Further, the cloud server 30 may take additional steps to secure the data received by the enterprise, such as using a secure communication channel, encrypting data for transmission, encrypting data for storage, and so forth.

In some systems, the rules 358 may be delivered with an OT device 308, such as stored in a memory of a local control system of the OT device 308. Once the local control system 346 is communicatively coupled to the industrial control system 20 (e.g., at installation, first power on, initial commissioning), the local control system 346 may transmit the set of rules 358 to the edge device 310 via the industrial control system 20. The edge device 310 may associate the set of rules 358 to an identifier associated with that asset and the local control system 346 such that when future obtained data is received from the OT device 308, the rules 358 delivered with that specific OT device 308 can be applied.

In some systems, the cloud server 30 may receive updates to rules and the edge device 310 may receive periodically transmitted updated rules 358 (e.g., rule updates 362) to correspond to the changes in the rules. Rules may be changed in response to a change in an industry standard to be disseminated into the rules 358 of the industrial automation system 10 by the cloud server 30.

Rule generation or updates may be aided or performed by the cloud server 30 based on machine learning models. For example, the machine learning models may have access to some or all of the rules 358 and some or all of the process data and may provide recommended rules or insights based on the rules 358 and/or process data (e.g., aggregated data of datasets 336 received over time) to which it has access. Machine learning models may improve processing of the OT data 340 and/or IT data 344 based on the context data 354 transmitted with the processed subset of data 356, for example natural language processing-based machine learning models may analyze the context data 354 using “conversational” input-based analysis. Using similar conversational inputs in industrial automation application may further improve industrial automation implementations of machine learning since fewer computational resources may be spent training the machine learning models due to sharing sentence-based data training between industrial automation data, IT-side data, word processing training data, and the like. Sometimes the machine learning models may detect when an industry standard changes and promulgate the changes through the rules automatically or in response to an instruction from the cloud server 30 to do so. The cloud server 30 may receive feedback used to further train the machine learning models. The industry standard changes may be of the same type (e.g., conversational inputs). Thus, models used to process conversational inputs may be similarly applied to analyzing industry standard changes and thus cloud server 30 operations may improve from using fewer computing resources system-wide with consolidating modelling, and thus training computing resources, across different types of analysis (e.g., standard changes, industrial automation data, user inputs).

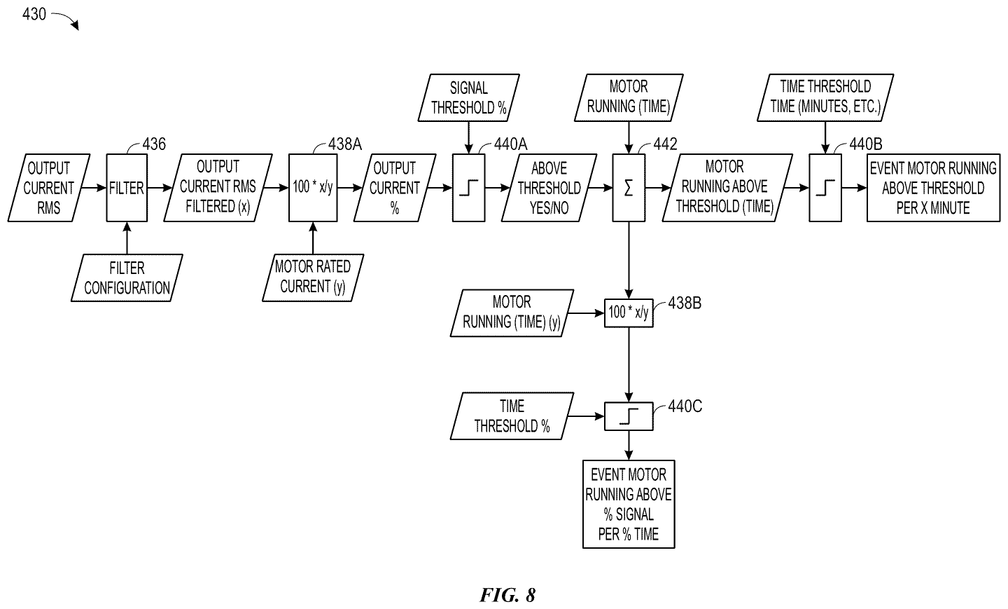

Rules 358, updates to rules 362, and the like, may be application-specific and highly flexible. Additional examples of rules 358 and system implementations are described herein, such as in reference to FIG. 8 and the other figures.

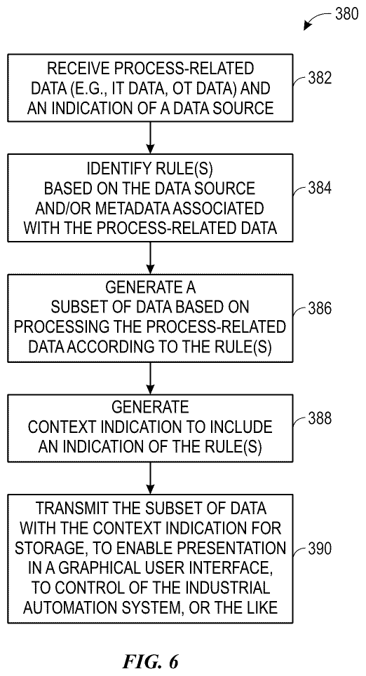

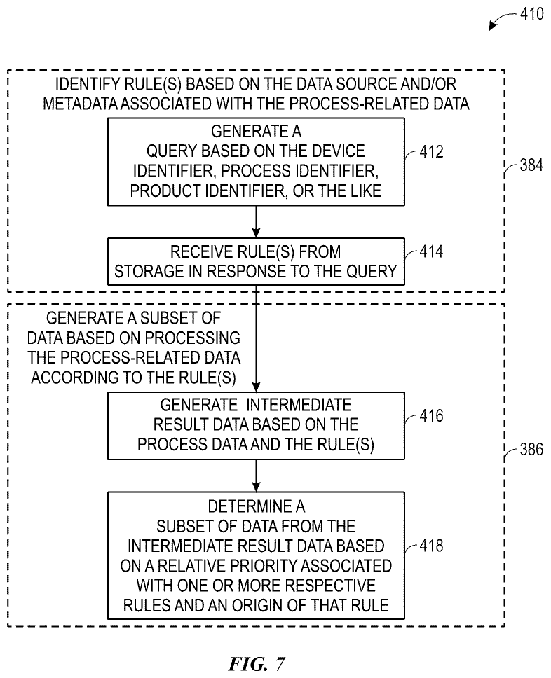

FIG. 6 is a flow chart of a process 380 of operating the edge device of FIG. 5 to generate the vital data and context data. Although the process 380 is described as being performed by the local control system 346, it should be understood that other suitable processing circuitry may be included in the edge device 310 to facilitate or enable performance of some or all of the operations described herein. In addition, although the process 380 is described in particular order, it should be understood that the process 380 may be performed in any suitable order and/or may include additional operations not described herein and/or exclude some of the operations described herein. Some or all of the operations described relative to process 380 are described herein and thus these descriptions made relative to FIGS. 5-8 are relied upon herein with FIG. 6-7.

At block 382, the local control system 346 may receive process-related data (e.g. IT data 344, OT data 340) and an indication of a data source from one or more OT devices 338 and/or one or more IT devices 342. The process-related data may be transmitted with metadata indicating a type of device that generated the data 340, 344, a type of the data 340, 344, a process associated with the data 340, 344, a process unit associated with the data 340, 344, or other suitable data indicated in metadata.

At block 384, the local control system 346 may identify one or more rules 358 based on the data source and/or the information indicated via the metadata. The identified rules 358 may be a subset of a total set of rules 358 stored in storage 332. The identified rules 358 may be selected based on target data (e.g., OT data 340, IT data 344) to be processed. For example, rules 358 to be applied to pump-related data may not be applied to fan-related data. Identifying the rules 358 in storage 332 may be based on generating a query based on a device identifier, a product identifier, a process identifier or the like.

At block 386, the local control system 346 may generate a subset of the process-related data (e.g., processed subset of data 356) based on processing the process-related data according to the rules 358 identified at block 384. With each rule, operation, analysis performed, or the like, on the data 340, 344, the local control system 346 may store an indication of such to transmit with the process subset of data 356. These operations may include generating metadata and appending the metadata to intermediate data generated by processing operations 348. The intermediate data and metadata may be received by subsequent processing operation 348 engines and/or processing operation 348 containers and updated accordingly for the subsequent processing operation 348. The intermediate data and metadata may be transmitted to local control circuitry 346. The local control system 346 may read the metadata and determine based on the rules 358 which processing operation 348 should be performed next on the intermediate data. In some systems, the processing operation 348 engines and/or processing operation 348 containers transmit or receive the intermediate data and the metadata without the local control system 346 being involved. To do so, the local control system 346 may program the path of processing into the edge device 310 and/or generate an indication of the path based on the rules 358 to be transmitted with the data 340, 344 throughout processing.

At block 388, the local control system 346 may generate context data 354 based on the metadata and/or stored indications of rules, operations, analysis performed, or the like. The context data 354 may indicate which operations were applied to the original set of data 340, 344 to arrive at the processed subset of data 356. The context data 354 may be conversational, per a set language. The context data 354 may correspond to a conversational code that the cloud server 30 may interpret. For example, the context data 354 may include “‘Event Motor Running Above Threshold Per’ [X] ‘Minutes’” and the processed subset of data 356 may include a definition for “[X]” as an indication of number of minutes, as determined from application of a subset of rules 358. For the above-example, the context data 354 could include a code “ABC” that the cloud server 30 and the local control system 346 both have been programmed to understand as communicating “‘Event Motor Running Above Threshold Per’ [X] ‘Minutes’” and the processed subset of data 356 may include a definition for “[X]” as an indication of number of minutes, as determined from application of a subset of rules 358. As another example, the processed subset of data 356 may be an alarm state. Context data 354 transmitted with the alarm state may communicate a threshold used to evaluate whether the data crossed the threshold, may communicate underlying data the alarm state corresponds to (e.g., a device), and a time stamp indicating when the alarm state occurred—and may do so using conversational outputs when the context generator 352 is programmed to do so.

At block 390, the local control system 346 may transmit the context data 354 and the resulting processed subset of data 356 to the cloud server 30. The cloud server 30 may use the context data 354 and the resulting processed subset of data 356 when generating graphical user interfaces, generating control signals or recommendations for the industrial automation system 10, or the like. With the context data 354 and the resulting processed subset of data 356 being provided, the cloud server 30 may not reference the underlying data to perform its further analysis and thus the whole underlying data to the cloud server 30 may not be provided as a way to reduce bandwidth and computing resources dedicated to the communicative coupling between the cloud server 30 and the edge device 310.

In some cases, at block 390, the local control system 346 may generate and send a control signal to the industrial control system 20 to cause the industrial control system 20 to implement a mitigation action at one or more OT devices. In some cases, at block 390, the local control system 346 may send the context data 354 and the processed subset of data 356 to the industrial control system 20 and the industrial control system 20 may determine control signals to generate based on a mitigation action to be taken to correct a operation indicated via the context data 354 and/or the processed subset of data 356.

FIG. 7 is a flow chart of a process 410 of operating the edge device of FIG. 5 to generate the vital data and context data. Although the process 410 is described as being performed by the local control system 346, it should be understood that other suitable processing circuitry may be included in the edge device 310 to facilitate or enable performance of some or all of the operations described herein. In addition, although the process 410 is described in particular order, it should be understood that the process 410 may be performed in any suitable order and/or may include additional operations not described herein and/or exclude some of the operations described herein. Some or all of the operations described relative to process 410 are described herein and thus these descriptions made relative to FIGS. 5-8 are relied upon herein with FIG. 6-7.

Referring back to FIG. 6, at block 384, the local control system 346 may perform operations of block 384 based on operations of block 412 and 414. Furthermore, at block 386, the local control system 346 may perform operations of block 386 based on operations of block 416 and 418.

To elaborate, the local control system 346 may identify rules 358 based on the data source and/or metadata associated with the process-related data based on, at block 412, generating a query based on the device identifier, a process identifier, a product identifier, or the like. At block 414, the local control system 346 may receive indications of the rules from storage 332 in response to the query of block 412. Rules 358 in storage 332 may be received from the cloud server 30, the IT devices 342, an operator via the industrial control system 20, or the like. Priorities may be associated with the source of the rule 358 and/or the rule itself to help prioritize between the different originators. For example, the local control system 346 may prioritize one result data over another result data based on which entity (e.g., cloud server 30, enterprise system 320, IT side system 314, industrial control system 20) generated the rule 358. A cloud server-generated “floor” rule 358 may have a lower priority than an enterprise system-generated more stringent rule 358 based on priorities associated with the rules 358.

In some systems, the local control system 346 may discard the lower priority rule when it is returned from the query. However, in some systems, the local control system 346 may perform the processing operations according to the one or more conflicting rules and decide at the end which final result to keep based on another rule.

For example, the local control system 346 may generate a subset of data 356 based on processing the process-related data 340, 344 according to the rules 358 received at block 414 based on, at block 416, the local control system 346 may generate two or more intermediate result data based on the process-related data 340, 344 and the rules received at block 414. At block 418, the local control system 346 may determine a subset of data from the two or more intermediate result data based on a relative priority associated with one or more respective rules 358 and an origin of the rule 358.

Keeping the foregoing in mind, FIG. 8 is a diagrammatic representation 430 of an example of generating the vital data (e.g., the subset of data 356) and context data 354 based on operations of FIGS. 5-7. A rule 358 may define operations and combinations of data 340, 344 to result in a dataset 336 of “Event Motor Running Above Threshold for X minutes” output from block 440B. The rule 358 may indicate through an indication of a trigger that another rule 358 at block 442 is to be applied to the result of “Above Threshold Yes/No” to eventually result (e.g., after prescribed operations) in a dataset 336 of “Event Motor Running Above % Signal Per % Time” output from block 440C. Both rules 358 may be based on the intermediate result data “Output Current RMS Filtered (x)” generated based on a filter operation of 436 and intermediate result data “Output Current %” generated based on a multiplier operation of block 438A (e.g., “100*x/y” a percentage operation). After the trigger to call the second rule 358, the rules 358 may use different input data 340, 344. In the outputs from block 442B, as an example, “X” may be the subset of data 356 set from the analysis performed and “Event Motor Running Above Threshold for” and “minutes” may be the context data 354 set by indications of the rules 358 applied during the analysis. Examples of input data 340, 344 for the rule 358 include “output current RMS,” “filter configuration,” “Motor Rated Current (y),” “Signal Threshold %,” “Motor Running (Time),” and the like.

Rules depicted in FIG. 8 include multiplier operations of blocks 438, filtering operations of blocks 436, summing operations of block 442, and thresholding operations of blocks 440. These may be examples of operations to perform via processing operations 348 of FIG. 5. Any suitable operation may be performed as part of a rule at the processing operations 348 of FIG. 5.

Other example rules are described herein and it should be noted that these are merely examples and other suitable rules and applications may be used in conjunction with the operations described herein relative to FIGS. 1-7. In some systems, a rule may define a threshold for a first type of asset, where the threshold may be used to identify whether a process dataset indicates that an asset (of the first type) is experiencing an active fault. In some systems, a rule may define, when the active fault is identified, a series of processing operations to be performed to identify whether that asset with the active fault was running, ramping up, ramping down, idle, or the like when the active fault occurred. Thus, the rule may define additional process data to be processed when processing the process dataset. In some systems, a rule may define a first operational range that complies with industry-wide operational specification and another rule may define a second operational range within the first operational range that complies with an enterprise-wide operational specification. In some systems, a rule may define that voltage data be averaged in response to the voltage data being identified as originating from a building flagged for power consumption analysis, where the flagging may be maintained in a separate data structure accessible by the edge device. In some systems, a rule may define which rule to apply to a process dataset in the event that multiple rules conflict about a processing operation or how to handle processed data to generate a vital. Thus, one or more rules may implement a rule hierarchy to control what rules win when there is a conflict between priorities or outputs of one or more rules. In some systems, a rule may define what combination of ingredients to be used to trigger performance of another one or more rules. For example, a rule may define a processing operation to be performed when the process data indicates X ingredient (e.g., type of wood pulp, type of liquid) is being processed. Thus, rules applied may change based on process state or what set of ingredients or materials are being processing by some or all of the industrial automation system. In some systems, a rule may define a rule to apply when the asset is determined, from the process data, to be in a particular gear or process state. In some systems, a rule may define a rule to apply when the process data indicates the asset is under a threshold amount of mechanical stress. In some systems, a rule may define additional data to be sent with the process data as inputs to a next rule for further processing. Data processing based on rules operations described herein may be similarly applied to process data generated by OT devices and/or IT devices, and thus use of the term “asset” herein may refer to either OT devices and/or IT devices unless otherwise specified.

In some cases, computing systems associated with third-parties that manage industry standards may transmit rules, or updates to rules, to the cloud server 30 as a way to implement a rule corresponding to an industry standard. For example, the cloud server 30 may receive an update to a rule 358 based on an industry standard governing one or more operations of the enterprise system 320. The industrial automation system 10 and/or the cloud server 30 may generate additional rules 358 based on the change in rule 358 from the industry standard to further customize implementation of the change to existing rules or policies in place to be complied with by the enterprise system 320.

As also described herein, as described above relative to at least FIGS. 3-4, these feature extraction operations described at least relative to FIGS. 5-8 may be deployed as part of a containerized application (e.g., container-based MPC system) executed on the edge device 310. Indeed, the industrial automation system 10 may include the container orchestration system 222 in the OT network. The container orchestration system 222 may work in tandem with the IT network 312 and/or industrial control systems 20 to control, monitor, and otherwise manage devices of the industrial automation system 10. In this way, the container orchestration system 222 may collect and analyze data from OT devices 308. Containers include packages of software that may include various elements needed to run in one or more software environments. Containers may be deployed as individual software modules that perform specific operations or functions on the data provided to the respective container. When the container is done performing the desired operation, it may be spun down or terminated to free up previously consumed computing resources. Thus, combining container operations with the feature extraction operations may improve system operations, such as by enabling the edge device 310 to selectively perform one or more of the processing operations 348 based on the rules 358 defining which containers to be spun up or down at a given time.

Systems and methods herein may be used to perform feature extraction on data associated with industrial automation systems to enable reduced amounts of data, preprocessed data, or highly tailored data to be transmitted to a service provider or IT network for further processing. Since sending data up into the cloud for processing and then bringing the data back down to the edge device and/or the industrial automation device, can be very expensive, doing most of the features extraction and/or data processing on the edge device and then sending results via cloud may yield the technical effect of reducing the amount of data being transmitted up to the cloud. An edge device included between the industrial automation system and the cloud to may be used to process the large quantities of data from the asset based on rules to generate a smaller subset of data to be transmitted to the cloud. Doing so may yield the technical effect of larger amounts of data being able to be processed as part of analytic operations without increasing bandwidth burdens and further slowing communication speeds or efficiencies.

Systems and methods herein also enable rule updates and different types of priorities to be used among different rules. By doing so, an edge device may determine when to apply rules from the cloud server and when to apply rules from another source, like an IT device of an enterprise system. The edge device decision making may be made based on relative strictness of the respective rules. For example, when one or more rules cause generation of an alarm at a less strict level than that specified by one or more rules generated by the cloud server, the local control circuitry may apply the one or more rules generated by the cloud server. When one or more rules generated by an IT device yield more strict operation than that provided by the cloud server, the local control circuitry may apply the one or more rules generated by the IT device. This decision making may be performed on a feature-extraction-by-feature-extraction basis as opposed to being a global setting. Doing so may improve industrial automation system operation by automating regulatory compliance by reducing a likelihood intentional or unintentional circumvention of governance (e.g., by one IT devices of the enterprise) and enabling third-party service providers to consume computing resources managing the rules as opposed to enterprise system.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system comprising:
an edge device communicatively coupled to an industrial control system via a local control system, wherein the edge device comprises the local control system that is configured to:
receive, via the industrial control system, process-related data obtained in association with an industrial automation device disposed within an operational technology network and a device identifier of the industrial automation device;
read, via a memory, one or more rules based on the device identifier and a type of the process-related data, wherein the one or more rules comprise:
a first rule having a first priority; and
a second rule having a second priority;
determine to apply the first rule based on the first priority exceeding the second priority;
generate a subset of processed data based on processing the process-related data according to the first rule and one or more additional rules of the one or more rules;
generate context data comprising an indication of the first rule and the one or more additional rules;
send the subset of processed data and the context data to a cloud server outside the operational technology network; and
control operation of the industrial automation device based on the subset of processed data.

2. The system of claim 1, wherein the first rule comprises an enterprise-specific rule having the first priority, and wherein the second rule comprises an industry-specific rule having the second priority.

3. The system of claim 1, wherein the local control system is configured to:
generate an intermediate result based on processing the process-related data after being instructed by the first rule to perform a first operation on the process-related data; and
generate the subset of processed data based on processing the process-related data after being instructed by a third rule of the one or more additional rules to perform a second operation on the intermediate result.

4. The system of claim 1, wherein the memory receives the first rule, the second rule, and the one or more additional rules from the cloud server.

5. The system of claim 1, wherein the local control system is configured to:
receive the process-related data using a first amount of computing resources; and
transmit, via a wireless communicative coupling, the subset of processed data and the context data using a second amount of computing resources less than the first amount of computing resources.

6. The system of claim 5, wherein the edge device is disposed on a network edge between an enterprise system comprising the operational technology network and a communication network associated with the cloud server.

7. The system of claim 1, wherein the edge device is configured to receive updated rules from the cloud server to replace the one or more additional rules, the first rule, the second rule, or any combination thereof, and wherein the updated rules corresponds to an update in an industry standard.

8. The system of claim 1, wherein the one or more additional rules are configured to instruct a filtering operation and a thresholding operation.

9. The system of claim 1, wherein the local control system is configured to:
generate the process-related data based on an operation executed in a container based on the first rule; and
spin down the container after generating the subset of processed data and the context data.

10. An edge device, comprising:
an input structure configured to couple to an industrial control system communicatively coupled to an industrial automation device disposed within an operational technology network;
a processor; and
a memory, accessible by the processor, configured to store:
a first rule indicating a first operation and a second operation to be performed; and
instructions that, when executed by the processor, cause the processor to perform operations comprising:
receiving, from the industrial control system, process-related data associated with the industrial automation device and a device identifier of the industrial automation device;
reading, from the memory, the first rule based on the device identifier and a type of the process-related data;
generating a subset of processed data based on processing the process-related data according to the first operation and the second operation based on the first rule;
generating context data based on an indication of the first rule; and
sending, to a cloud server outside the operational technology network, the subset of processed data and the context data.

11. The edge device of claim 10, wherein the processor is configured to perform operations comprising generating, via the industrial control system, a control signal to adjust operation of the industrial automation device based on the subset of processed data.

12. The edge device of claim 10, wherein the process-related data comprises operational technology network data and information technology network data.

13. The edge device of claim 10, wherein the processor is configured to perform operations comprising:
receiving a second rule in response to the industrial automation device being installed; and
storing the second rule to the memory.

14. The edge device of claim 13, wherein the processor is configured to perform operations comprising:
receiving the first rule from the cloud server after receiving the second rule; and
storing the first rule over the second rule based on the first rule changing the second rule.

15. A method, comprising:
receiving, from an industrial automation device associated with an industrial automation system and disposed within an operational technology network, process-related data and a device identifier of the industrial automation device;
reading from memory a rule based on the device identifier and a type of the process-related data;
generating a subset of processed data based on processing the process-related data according to the rule;
generating context data comprising an indication of the rule; and
transmitting the subset of processed data and the context data to an information technology device associated with the industrial automation system and disposed within an informational technology network.

16. The method of claim 15, comprising:
receiving a first rule having a first threshold;
receiving a second rule having a second threshold;
determining the second threshold is less than the first threshold based on comparing the first rule and the second rule; and
generating the subset of processed data according to the rule based on using the first rule as the rule in response to determining that the second threshold is less than the first threshold.

17. The method of claim 15, wherein processing the process-related data according to the rule comprises:
processing operational technology network data in a first operation instructed by the rule; and
processing informational technology network data in a second operation instructed by the rule to occur based on an intermediate result from the first operation.

18. The method of claim 17, wherein processing the process-related data according to the rule comprises:
determining that the industrial automation device is experiencing a fault based on data processed via the second operation; and
sending a control signal to an industrial control system to implement a mitigation action to remedy the fault.

19. The method of claim 18, wherein generating the context data comprises generating the context data to include an indication of the fault as the indication of the rule.

20. The method of claim 18, wherein the second operation comprises determining, based on one or more work orders of the informational technology network data, that intermediate data generated from the first operation corresponds to an unexpected operation of the industrial automation device.
